(19) United States
(12) Patent Application Publication
(10) Pub. No.: US 2017/0139908 A1
(43) Pub. Date: May 18, 2017

(54) TECHNOLOGY TREND PREDICTING METHOD AND SYSTEM AND NON-TRANSITORY COMPUTER READABLE STORAGE MEDIUM

(71) Applicant: INSTITUTE FOR INFORMATION INDUSTRY, Taipei (TW)

(72) Inventor: Hung-Sheng CHIU, Taipei City (TW)

(21) Appl. No.: 15/236,492

(22) Filed: Aug. 15, 2016

(30) Foreign Application Priority Data
Nov. 13, 2015 (TW) 104137573

(51) Int. Cl. G06F 17/30; G06N 5/02

(52) U.S. Cl. CPC G06F 17/30011; G06F 17/30657; G06N 5/022; G06F 2216/11

(57) ABSTRACT

A technology trend predicting method includes: searching a patent database to acquire a plurality of patent data corresponding to a specific technology; generating first patent information; receiving a plurality of commercial data from a commercial database; establishing one commercial model according to the plurality of commercial data and at least one weighting; utilizing the at least one commercial model to generate commercial trend information corresponding to the first patent information according to a plurality of target commercial data associated with the plurality of patent data; generating second patent information according to the commercial trend information; receiving a plurality of predicting commercial data from the commercial database; generating third patent information according to the plurality of predicting commercial data; and generating technology trend predicting information according to the first patent information, the second patent information, and the third patent information.

### RELATED APPLICATIONS

This application claims priority to Taiwanese Application Serial Number 104137573, filed Nov. 13, 2015, which is herein incorporated by reference.

### BACKGROUND

Technical Field

The present disclosure relates to a prediction technology. More particularly, the present disclosure relates to a technology trend predicting method and technology trend predicting system.

Description of Related Art

Since a user can know technology development through a technology trend prediction, the technology trend prediction has been a very important topic in technology development. Patent data is used for the technology trend prediction at present. However, since the latest patent data is published in delay, a technology trend predicting result calculated only on known patent data will be not accurate. Moreover, the industry circle not only needs to predict the technology trend, but also needs to be able to send out a warning when the technology trend changes. However, it is hard to send out the warning in effect for the technology trend if the technology trend predicting result is not accurate.

### SUMMARY

One embodiment of the present disclosure is related to a technology trend predicting method performed by a processing device. The technology trend predicting method includes: searching a patent database to acquire a plurality of patent data corresponding to a specific technology by the processing device; generating first patent information according to the plurality of the patent data by the processing device; receiving a plurality of commercial data corresponding to the plurality of the patent data from a commercial database by the processing device; establishing at least one commercial model according to the plurality of commercial data and at least one weighting by the processing device; utilizing the at least one commercial model to generate commercial trend information corresponding to the first patent information according to a plurality of target commercial data associated with the plurality of patent data by the processing device; generating second patent information according to the commercial trend information by the processing device; receiving a plurality of predicting commercial data corresponding to the target commercial data from the commercial database by the processing device; generating third patent information according to the plurality of predicting commercial data by the processing device; and generating technology trend predicting information by the processing device according to the first patent information, the second patent information, and the third patent information.

Another embodiment of the present disclosure is related to a technology trend predicting system. The technology trend predicting system includes a searching module, a patent trend module, a receiving module, a commercial trend module, and a predicting module. The searching module is configured to search a patent database to acquire a plurality of patent data corresponding to a specific technology. The patent trend module is configured to generate first patent information according to the plurality of the patent data. The receiving module is configured to receive a plurality of commercial data corresponding to the plurality of the patent data from a commercial database. The commercial trend module is configured to establish at least one commercial model according to the plurality of commercial data and at least one weighting. The commercial trend module is configured to utilize the at least one commercial model to generate commercial trend information corresponding to the first patent information according to a plurality of target commercial data associated with the plurality of patent data. The receiving module is further configured to receive a plurality of predicting commercial data corresponding to the target commercial data from the commercial database. The patent trend module is further configured to generate second patent information according to the commercial trend information, and configured to generate third patent information according to the plurality of predicting commercial data. The predicting module is configured to generate technology trend predicting information according to the first patent information, the second patent information, and the third patent information.

Yet another embodiment of the present disclosure is related to a non-transitory computer readable storage medium storing a computer program. The computer program is configured to execute a technology trend predicting method. The technology trend predicting method includes: searching a patent database to acquire a plurality of patent data corresponding to a specific technology; generating first patent information according to the plurality of the patent data; receiving a plurality of commercial data corresponding to the plurality of the patent data from a commercial database; establishing at least one commercial model according to the plurality of commercial data and at least one weighting; utilizing the at least one commercial model to generate commercial trend information corresponding to the first patent information according to a plurality of target commercial data associated with the plurality of patent data; generating second patent information according to the commercial trend information; receiving a plurality of predicting commercial data corresponding to the target commercial data from the commercial database; generating third patent information according to the plurality of predicting commercial data; and generating technology trend predicting information according to the first patent information, the second patent information, and the third patent information.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram illustrating a technology trend predicting system according to one embodiment of the present disclosure;

FIG. 2-FIG. 9 are schematic diagrams illustrating a technology trend predicting method generated according to one embodiment of this disclosure; and

FIG. 10 is flow diagram illustrating a technology trend predicting method according to one embodiment of this disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. The embodiments below are described in detail with the accompanying drawings, but the examples provided are not intended to limit the scope of the disclosure covered by the description. The structure and operation are not intended to limit the execution order. Any structure regrouped by elements, which has an equal effect, is covered by the scope of the present disclosure.

Moreover, the drawings are for the purpose of illustration only, and are not in accordance with the size of the original drawing. The components in description are described with the same number to understand.

Unless otherwise defined, all terms used in this specification and claims generally have their ordinary meaning in the art, within the context of the disclosure, and in the specific context where each term is used. Certain terms that are used to describe the disclosure are discussed below, or elsewhere in the specification, to provide additional guidance to the practitioner regarding the description of the disclosure.

As used herein with respect to the “first”, “second” . . . is not special order or pick the alleged meaning, but simply to distinguish the operation described in the same terms or elements of it.

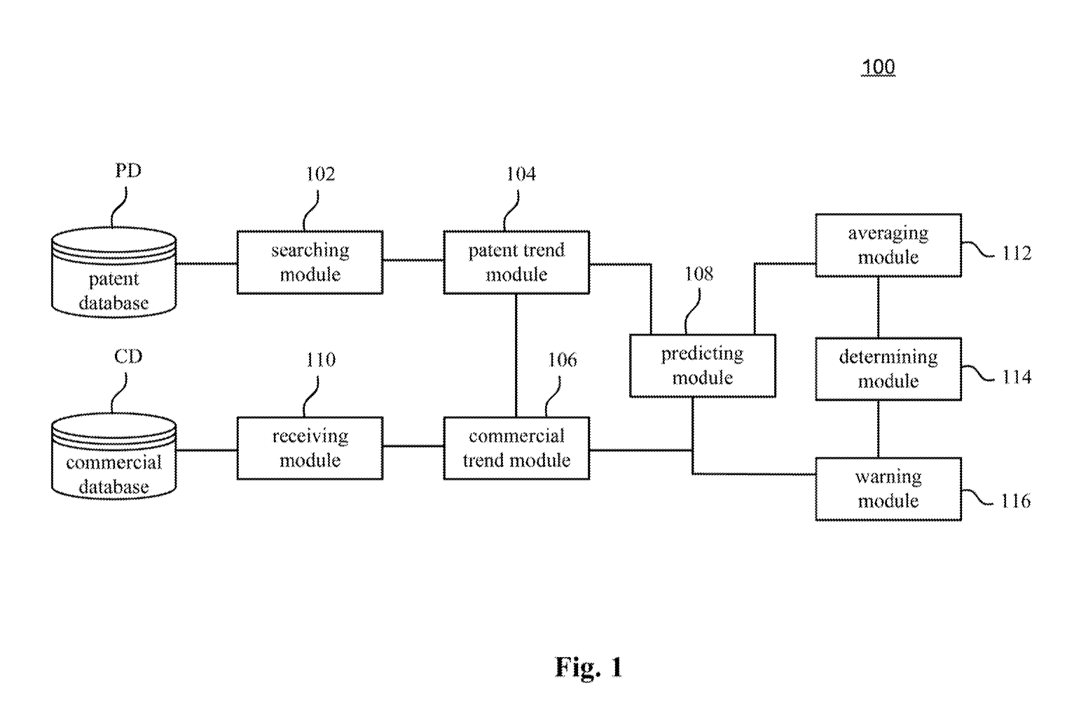

FIG. 1 is a block diagram illustrating a technology trend predicting system 100 according to one embodiment of the present disclosure. As illustrated in FIG. 1, in some embodiments, the technology trend predicting system 100 includes a searching module 102, a patent trend module 104, a commercial trend module 106, and a predicting module 108. In some embodiments, the technology trend predicting system 100 further includes a patent database PD, a commercial database CD, and a receiving module 110.

The searching module 102 is coupled to the patent database PD and the patent trend module 104. The receiving module 110 is coupled to the commercial database CD and the commercial trend module 106. The predicting module 108 is coupled to the patent trend module 104 and the commercial trend module 106.

A used herein, “coupled” or “connected” may refer to two or more elements are in direct physical or electrical contact made, or indirectly, as a mutual entity or electrical contact, and “coupled “or” connected “may also refer to two or more elements are operating or action.

As mentioned above, the searching module 102, the patent trend module 104, the commercial trend module 106, the predicting module 108 or the receiving module 110 may be implemented in terms of software, hardware and/or firmware. For instance, if the execution speed and accuracy have priority, the above-mentioned modules may be implemented in terms of hardware and/or firmware. If the design flexibility has higher priority, then the above-mentioned modules may be implemented in terms of software. Furthermore, the above-mentioned modules may be implemented in terms of software, hardware and firmware in the same time. It is noted that the foregoing examples or alternates should be treated equally, and the present disclosure is not limited to these examples or alternates. Anyone who is skilled in the prior art can make modification to these examples or alternates in flexible way if necessary.

In some embodiments, the searching module 102, the patent trend module 104, the commercial trend module 106, the predicting module 108 or the receiving module 110 may be integrated into one or more processing devices. The processing device includes a CPU, a control element, a microprocessor, a server or other hardware element being able to execute instructions.

In some other embodiments, the searching module 102, the patent trend module 104, the commercial trend module 106, the predicting module 108 or the receiving module 110 may be implemented as a computer program and stored in a storing device. The storing device includes non-volatile computer-readable recording medium or other device with storing function. The computer program includes a plurality of program instructions. The CPU may execute the program instructions to perform functions of each module.

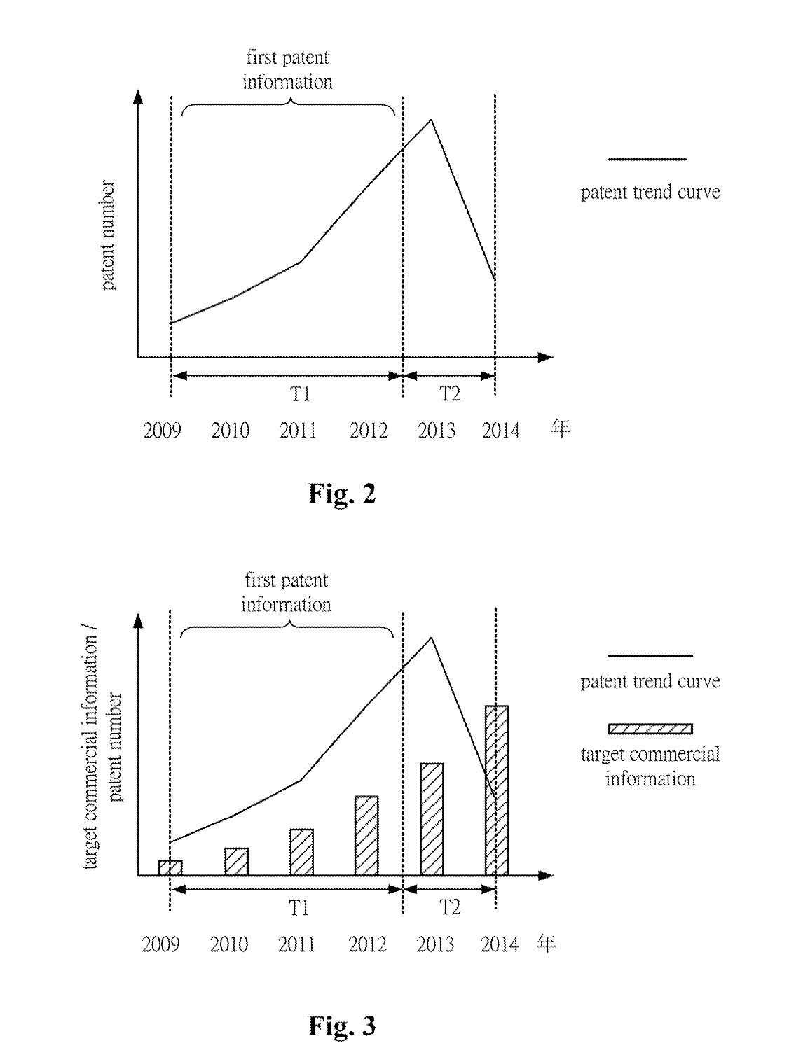

FIG. 2-FIG. 9 are schematic diagrams illustrating a technology trend predicting method generated according to one embodiment of this disclosure.

As illustrated in FIG. 1, the patent database PD is configured to store a plurality of patent data. The patent database PD may includes one or more specific patent database, such as a database of USPTO, a database of EPO or a database of TIPO (Taiwan Intellectual Property Office). If a user wants to know a technology trend predicting result of a specific technology, an operation interface is provided for the user to input keywords and/or technology classification corresponding to the specific technology. Moreover, the operation interface is also provided for the user to input related information (such as, applicant, application dates, and so on). In some embodiments, the technology classification may be patent classification number, for example, International Patent Classification (IPC), Cooperative Patent Classification (CPC) or other classification number. The searching module 102 may search a plurality of patent data corresponding to the specific technology from the patent database PD according to the keywords or technology classification. Moreover, the operation interface may be provided by the searching module 102 or by an operation interface module.

The searching module 102 acquires the plurality of patent data corresponding to the specific technology from the patent database PD according to the keywords and/or technology classification input from the operation interface. Then, the patent trend module 104 may generate patent trend information according to the application dates of the plurality of patent data, as illustrated in FIG. 2. The publication dates also can be used in other embodiments. The patent trend information in FIG. 2 is to take a trend curve corresponding to the numbers of patent applications each year as example, but is not limited thereof. A first time interval T1 and a second time interval T2 are defined on a time axle in FIG. 2. For example, the second time interval T2 is a time interval over eighteen months from now, and the first time interval T1 is a time interval before eighteen months ago. In other words, the patent data whose application date is in the first time interval T1 are completely published, but the patent data whose application date is in the second time interval T2 are not completely published. Thus, a portion of the patent trend curve corresponding to the first time interval T1 can reflect a patent application number of the first time interval T1 correctly, but a portion of the patent trend curve corresponding to the second time interval 2 can not correctly reflect a patent application number of the second time interval T2. The portion of the patent trend curve corresponding to the first time interval T1 is referred as first patent information.

The plurality of patents in the patent data corresponding to the specific technology may be held by a plurality of patent applicants. A patent applicant who holds more patents generally has a great effect upon the specific technology. Consequently, the patent trend module 104 may further acquires patent applicant data according to the plurality of patent data, and then the receiving module 110 receives a plurality of commercial data of the patent applicants who holds more patents from the commercial database CD. The commercial data may be sale information of a product corresponding to the specific technology of the patent applicants (such as, companies), stock market information of the patent applicants, stock trading volume information of the patent applicants, research and development cost information corresponding to the specific technology of the patent applicants, company financial report information of the patent applicants, investment information corresponding to the specific technology of the patent applicants, predicting sale information of a future product corresponding to the specific technology or a combination thereof of the patent applicants. The commercial data in the first time interval T1 and in the second time interval T2 of the patent applicants who holds more patent data are referred as target commercial data.

For example, it is assumed that the specific technology is an operation interface of a smart phone. The patent applicants who hold more patent data may be Apple Inc. or Samsung Inc. The patent trend curve in FIG. 2 may be a trend curve for patent application number over the past years corresponding to the operation interface of the smart phone. The target commercial data may be selling volumes of smart phones of Apple Inc. or Samsung Inc. over 2009-2014 years. It is assumed that the specific technology is 3D printer, the patent applicants who hold more patent data may be Stratasys, MakerBot, 3D Systems, Autodesk, XYZPRINTING etc. The target commercial data in FIG. 2 may be selling volumes of 3D printers or market values of Stratasys, MakerBot, 3D Systems, Autodesk, XYZPRINTING etc. over 2009-2014 years.

Then, as illustrated in FIG. 3, the commercial trend module 106 utilizes algorithm to establish many commercial models. Different commercial models may have different kind of commercial data and corresponding weightings. First, the commercial trend module 106 utilizes these commercial models to calculate the target commercial data in the first time interval T1 respectively to generate many commercial trend information of the first time interval T1 (such as bars in FIG. 3). If commercial trend information generated through one of the commercial models satisfies the trend of the first patent information, as illustrated in FIG. 3, the one of the commercial models is selected.

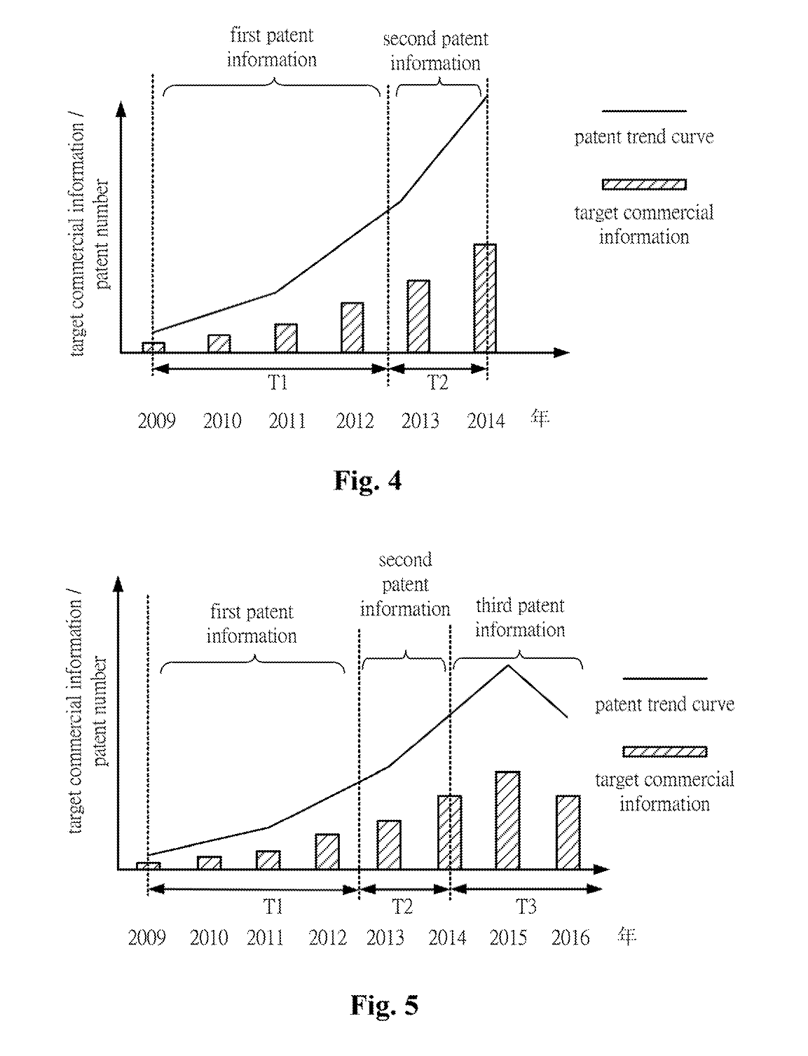

At the same time, the commercial trend module 106 utilizes the selected commercial module to calculate the target commercial data in the second time interval T2, to generate commercial trend information of the second time interval T2. Then, the patent trend module 104 modifies the portion of the patent trend curve corresponding to the second time interval T2 according to the commercial trend information of the second time interval T2, as illustrated in FIG. 4. Consequently, the patent trend curve is more suitable for predicting a technology trend. The portion of the patent trend curve corresponding to the second time interval T2 is referred as second patent information.

Moreover, the receiving module 110 also receives a plurality of predicting commercial data of the applicants from the commercial database CD, such as a predicting selling volume, a predicting yield, a predicting revenue or research and development cost etc. These predicting commercial data is corresponding a third time interval T3, as illustrated in FIG. 5. In other words, the third time interval T3 is a time interval in the future. For example, the predicting commercial data may be predicting selling volumes of smart phones of Apple Inc. or Samsung Inc. after 2015 year. At the same time, the commercial trend module 106 utilizes the selected commercial module to calculate the predicting commercial data to generate commercial trend information of the third time interval T3. Then, the patent trend module 104 generates the portion of the patent trend curve corresponding to the third time interval 13 according to the commercial trend information of the third time interval T3, as illustrated in FIG. 5. The portion of the patent trend curve corresponding to the third time interval T3 is referred as third patent information.

In detail, the patent trend curve in FIG. 5 includes the first patent information, the second patent information and the third patent information.

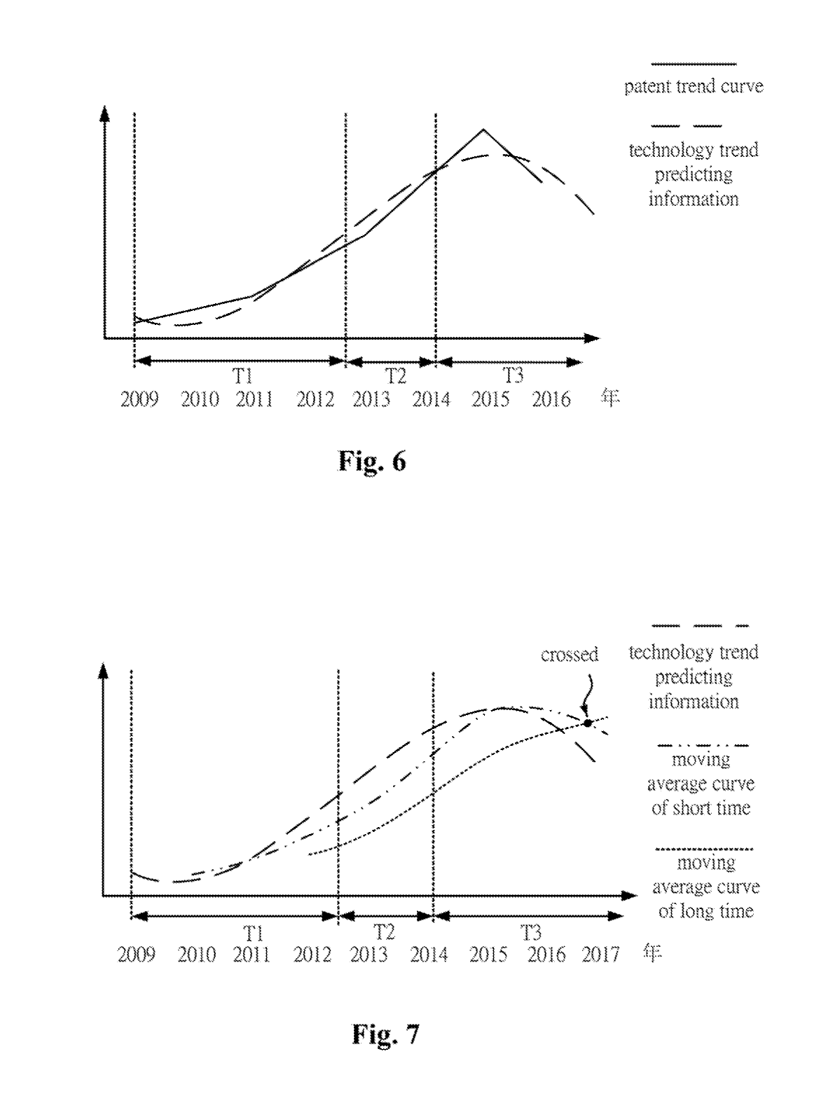

Then, as illustrated in FIG. 6 the predicting module 108 utilizes data smoothing technology (such as, polynomial smoothing technology) to smooth the patent trend curve in FIG. 5 to generate corresponding technology trend predicting information. The technology trend predicting information in FIG. 6 is to take a technology trend predicting “curve” as an example, but is not limited thereof. Since the patent data in the second time interval T2 and in the third time interval T3 have not been published completely, the technology trend predicting system 100 generates the second patent information corresponding to the second time interval T2 and the third patent information corresponding to the third time interval 13 according to the target commercial data, such that the second patent information and the third patent information are suitable as a basis for the technology trend prediction.

As illustrated in FIG. 1, in some embodiments, the technology trend predicting system 100 further includes an averaging module 112. The averaging module 112 is coupled to the predicting module 108. The averaging module 112 is configured to generate a moving average curve of long time average or a moving average curve of short time average according to the technology trend predicting information, as illustrated in FIG. 7. For example, the averaging module 112 separately averages five values of five adjacent years to generate the moving average curve of long time average. The averaging module 112 separately averages three values of three adjacent years to generate the moving average curve of short time average. In other words, the moving average curve of long time average is smoother than the moving average curve of short time average.

As illustrated in FIG. 1, in some embodiments, the technology trend predicting system 100 further includes a determining module 114 and a warning module 116. The determining module 114 is coupled to the averaging module 112 and the warning module 116. The determining module 114 is configured to determine whether the moving average curve of long time average and the moving average curve of short time average are crossed or not. It is indicated that the technology development trend may be slow or upside down when the moving average curve of long time average and the moving average curve of short time average are crossed. As illustrated in FIG. 7, the moving average curve of long time average and the moving average curve of short time average are crossed in 2017. At this time, the warning module 116 sends out warning information to warn related people. The related people are, for example, investors of the specific technology, researcher of the specific technology, manufacturers of the specific technology or users of the specific technology etc. In some embodiments, the warning information may be displayed through a graphic user interface (GUI), but is not limited thereof.

As mentioned above, the averaging module 112, the determining module 114 or the warning module 116 may be implemented in terms of software, hardware and/or firmware. In some embodiments, the averaging module 112, the determining module 114 or the warning module 116 may be integrated into a processing device. In some other embodiments, the averaging module 112, the determining module 114 or the warning module 116 may be implemented as a computer program.

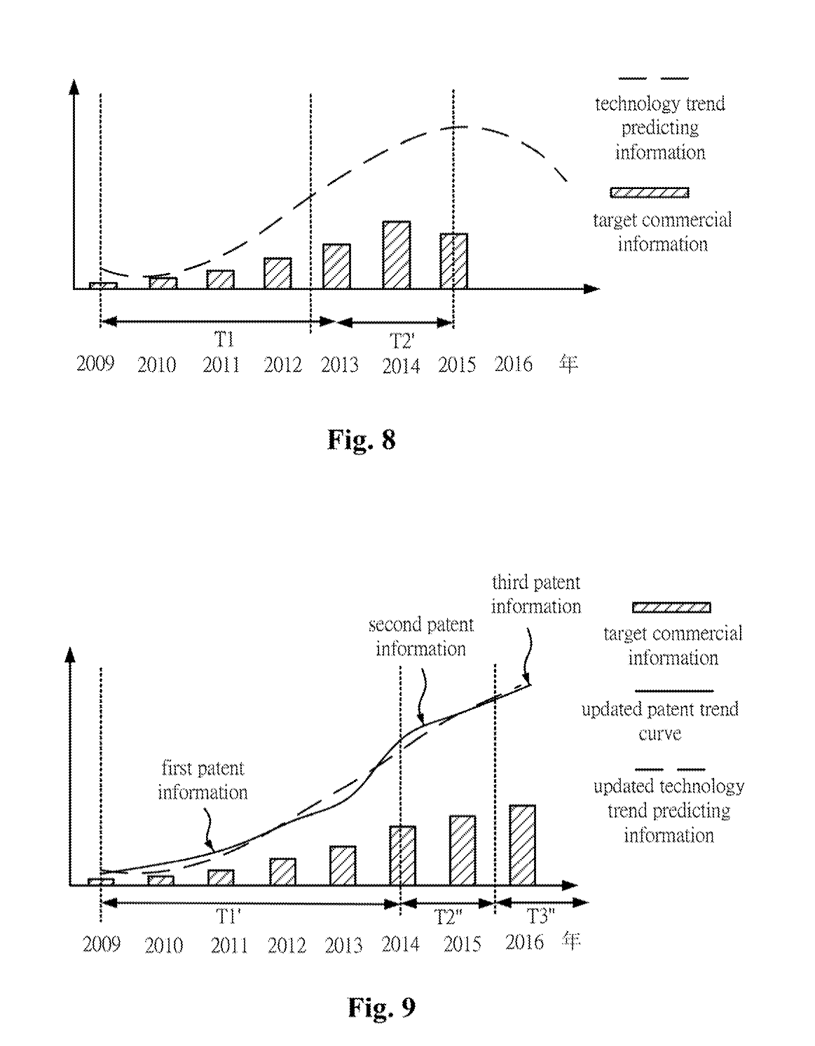

In some embodiments, the warning module 116 is coupled to the predicting module 108. The receiving module 110 is further configured to receive current target commercial data. The commercial trend module 106 is further configured to modify the commercial trend information according to the current target commercial data. For instance, as time goes on, a second time interval T2′ may include the year of 2015, as illustrated in FIG. 8. Thus, the current target commercial data may be real selling volume of smart phones of Apple Inc. and Samsung Inc. in 2015. The commercial trend module 106 subsumes the current target commercial data into the commercial trend information. As illustration in FIG. 8, a real selling volume of smart phones of Apple Inc. and Samsung Inc. in 2015 is much lower than a real selling volume of smart phones of Apple Inc. and Samsung Inc. in 2014, but the technology trend predicting curve indicates that the trend is upward. In other words, the commercial trend information modified according to the current target commercial data is not satisfied with the technology trend predicting information. This may indicate that the selling volume of the product is not as expected. At this time, the warning module 116 sends out the warning information.

In some embodiments, as illustrated in FIG. 9, a first time interval T1′ is a time interval before the year of 2014 as time goes on. In other words, the patent data whose application date are in a range from July, 2012 to 2014 are completely published. At this time, the patent trend module 104 may update the patent trend curve according to the patent data.

Moreover, the receiving module 110 also may receive a plurality of target commercial data corresponding to the year of 2015. The commercial trend module 106 updates the commercial trend information according to the plurality of target commercial data corresponding to the year of 2015. At this time, the patent trend module 104 may update the second patent information corresponding to the second time interval T2″ and update the third patent information corresponding to the third time interval T3″ according to the updated commercial trend information, as illustrated in FIG. 9. Then, the predicting module 108 updates the technology trend predicting information according to the updated first patent information, the updated second patent information and the updated third patent information.

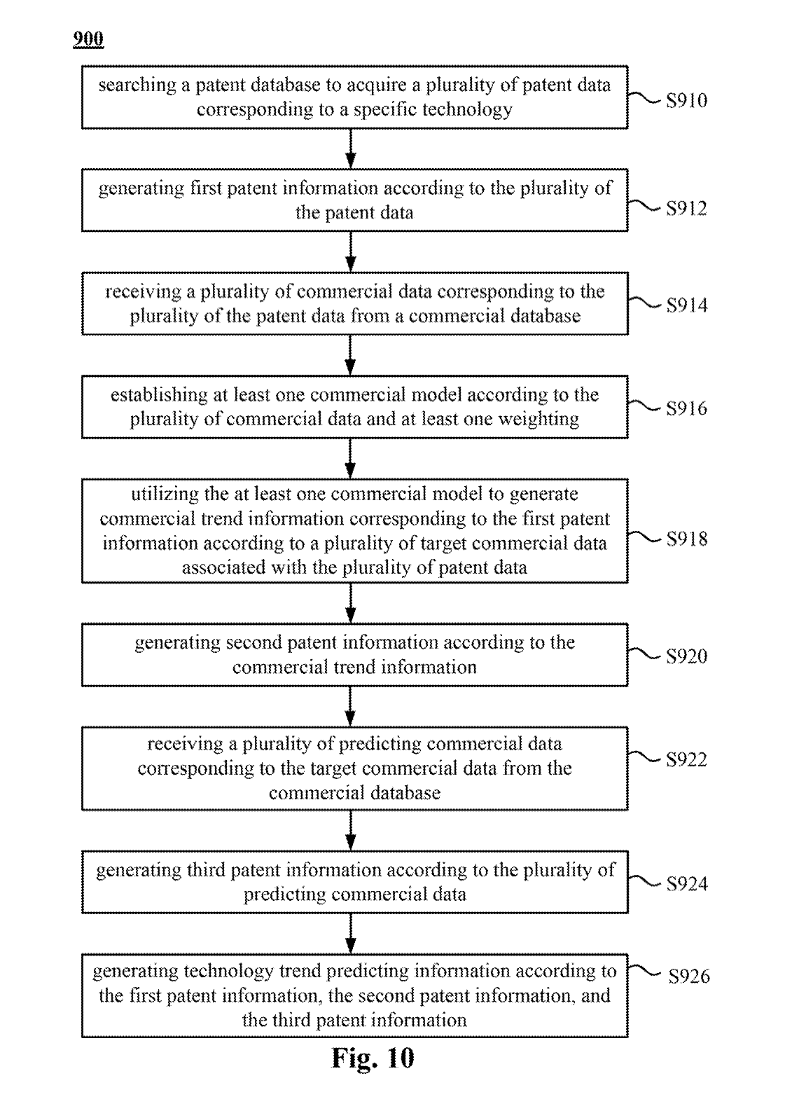

FIG. 10 is flow diagram illustrating a technology trend predicting method 900 according to one embodiment of this disclosure. As illustrated in FIG. 10, the technology trend predicting method 900 includes steps S910, S912, S914, S916, S918, S920, S922, S924, and S926. In some embodiments, the technology trend predicting method 900 in FIG. 10 may be implemented in the technology trend predicting system 100 in FIG. 1.

The step S910 is for searching a patent database to acquire a plurality of patent data corresponding to a specific technology.

The step S912 is for generating first patent information according to the plurality of the patent data.

The step S914 is for receiving a plurality of commercial data corresponding to the plurality of the patent data from a commercial database.

The step S916 is for establishing at least one commercial model according to the plurality of commercial data and at least one weighting.

The step S918 is for utilizing the at least one commercial model to generate commercial trend information corresponding to the first patent information according to a plurality of target commercial data associated with the plurality of patent data.

The step S920 is for generating second patent information according to the commercial trend information.

The step S922 is for receiving a plurality of predicting commercial data corresponding to the target commercial data from the commercial database.

The step S924 is for generating third patent information according to the plurality of predicting commercial data.

The step S926 is for generating technology trend predicting information according to the first patent information, the second patent information, and the third patent information.

A detail description about the technology trend predicting method 900 may refer to the above detail content and description about the technology trend predicting system 100, so a detail description in this regard will not be provided here again. Moreover, the above illustrations include exemplary operations in sequence, but the operations are not necessarily performed in the order shown. Various orders of the operations are within the contemplated scope of the present disclosure. Moreover, operations may be added, replaced, changed order, and/or eliminated as appropriate, in accordance with the spirit and scope of various embodiments of the present disclosure.

As the above embodiments, since the patent data in the second time interval and in the third time interval have not been published completely, the technology trend predicting method and system of this disclosure generate the portions corresponding to the second time interval and the third time interval of the patent trend curve according to the target commercial data. Consequently, the patent trend curve is further configured to accurately predict a technology trend. Moreover, since a technology trend predicting result is more accurate, a warning is accurately output according to the technology trend predicting result that is more accurate.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A technology trend predicting method performed by a processing device, wherein the technology trend predicting method comprises:
searching a patent database to acquire a plurality of patent data corresponding to a specific technology by the processing device;
generating first patent information according to the plurality of the patent data by the processing device;
receiving a plurality of commercial data corresponding to the plurality of the patent data from a commercial database by the processing device;
establishing at least one commercial model according to the plurality of commercial data and at least one weighting by the processing device;
utilizing the at least one commercial model to generate commercial trend information corresponding to the first patent information according to a plurality of target commercial data associated with the plurality of patent data by the processing device;
generating second patent information according to the commercial trend information by the processing device;
receiving a plurality of predicting commercial data corresponding to the target commercial data from the commercial database by the processing device;
generating third patent information according to the plurality of predicting commercial data by the processing device; and
generating technology trend predicting information by the processing device according to the first patent information, the second patent information, and the third patent information.

2. The technology trend predicting method of claim 1, wherein the first patent information is corresponding to a first time interval, the second patent information is corresponding to a second time interval, and the third patent information is corresponding to a third time interval.

3. The technology trend predicting method of claim 2, wherein the first time interval is before the second time interval, and the second time interval is before the third time interval.

4. The technology trend predicting method of claim 1, further comprising:
generating a moving average curve of long time average and a moving average curve of short time average according to the technology trend predicting information by the processing device; and
sending out warning information by the processing device when the moving average curve of long time average and the moving average curve of short time average are crossed.

5. The technology trend predicting method of claim 1, further comprising:
receiving a current target commercial data by the processing device;
modifying the commercial trend information according to the current target commercial data by the processing device; and
sending out warning information when the modified commercial trend information is incompatible with the technology trend predicting information by the processing device.

6. The technology trend predicting method of claim 1, further comprising:
updating the commercial trend information when the target commercial data are updated by the processing device; and
updating the second patent information and the third patent information according to the updated commercial trend information by the processing device.

7. The technology trend predicting method of claim 1, wherein the target commercial data are corresponding to sale information of products of at least one applicant of the patent data, stock market information of the at least one applicant, stock trading volume information of the at least one applicant, research and development cost information of the at least one applicant, company financial report information of the at least one applicant or a combination thereof.

8. A technology trend predicting system, comprising:
a searching module configured to search a patent database to acquire a plurality of patent data corresponding to a specific technology;
a patent trend module configured to generate first patent information according to the plurality of the patent data;
a receiving module configured to receive a plurality of commercial data corresponding to the plurality of the patent data from a commercial database;
a commercial trend module configured to establish at least one commercial model according to the plurality of commercial data and at least one weighting, and configured to utilize the at least one commercial model to generate commercial trend information corresponding to the first patent information according to a plurality of target commercial data associated with the plurality of patent data, wherein the receiving module is further configured to receive a plurality of predicting commercial data corresponding to the target commercial data from the commercial database, and the patent trend module is further configured to generate second patent information according to the commercial trend information, and configured to generate third patent information according to the plurality of predicting commercial data; and
a predicting module configured to generate technology trend predicting information according to the first patent information, the second patent information, and the third patent information.

9. The technology trend predicting system of claim 8, wherein the first patent information is corresponding to a first time interval, the second patent information is corresponding to a second time interval, and the third patent information is corresponding to a third time interval.

10. The technology trend predicting system of claim 9, wherein the first time interval is before the second time interval, and the second time interval is before the third time interval.

11. The technology trend predicting system of claim 8, further comprising:
an averaging module configured to generate a moving average curve of long time average and a moving average curve of short time average according to the technology trend predicting information.

12. The technology trend predicting system of claim 11, further comprising:
a determining module configured to determine whether the moving average curve of long time average and the moving average curve of short time average are crossed or not; and
a warning module configured to send out warning information when the moving average curve of long time average and the moving average curve of short time average are crossed.

13. The technology trend predicting system of claim 8, wherein the receiving module is further configured to receive a current target commercial data, the commercial trend module is further configured to modify the commercial trend information according to the current target commercial data, and the technology trend predicting system further comprises:
a warning module configured to send out warning information when the modified commercial trend information is incompatible with the technology trend predicting information.

14. The technology trend predicting system of claim 8, wherein the commercial trend module is further configured to update the commercial trend information when the target commercial data are updated.

15. The technology trend predicting system of claim 14, wherein the patent trend module is further configured to update the second patent information and the third patent information according to the updated commercial trend information.

16. A non-transitory computer readable storage medium storing a computer program, wherein the computer program is configured to execute a technology trend predicting method, and the technology trend predicting method comprises:
searching a patent database to acquire a plurality of patent data corresponding to a specific technology;
generating first patent information according to the plurality of the patent data;
receiving a plurality of commercial data corresponding to the plurality of the patent data from a commercial database;
establishing at least one commercial model according to the plurality of commercial data and at least one weighting;
utilizing the at least one commercial model to generate commercial trend information corresponding to the first patent information according to a plurality of target commercial data associated with the plurality of patent data;
generating second patent information according to the commercial trend information;
receiving a plurality of predicting commercial data corresponding to the target commercial data from the commercial database;
generating third patent information according to the plurality of predicting commercial data; and
generating technology trend predicting information according to the first patent information, the second patent information, and the third patent information.

17. The non-transitory computer readable storage medium of claim 16, wherein the first patent information is corresponding to a first time interval, the second patent information is corresponding to a second time interval, and the third patent information is corresponding to a third time interval.

18. The non-transitory computer readable storage medium of claim 17, wherein the first time interval is before the second time interval, and the second time interval is before the third time interval.

19. The non-transitory computer readable storage medium of claim 16, wherein the technology trend predicting method further comprises:
generating a moving average curve of long time average and a moving average curve of short time average according to the technology trend predicting information; and
sending out warning information when the moving average curve of long time average and a moving average curve of short time average are crossed.

20. The non-transitory computer readable storage medium of claim 19, wherein the technology trend predicting method further comprises:
receiving a current target commercial data;
modifying the commercial trend information according to the current target commercial data; and
sending out warning information when the modified commercial trend information is incompatible with the technology trend predicting information.
